(19) United States
(12) Patent Application Publication
(10) Pub. No.: US 2009/0280343 A1
(43) Pub. Date: Nov. 12, 2009

(54) Method for producing a heterogeneous, in particular multicolored, sheet-like structure, mold and sheet-like structure

(75) Inventors: Heinz Dieter Wellen, Krefeld (DE); Hubert Bruckner, Erkrath (DE); Peter Cempulik, Dortmund (DE)

Correspondence Address: FOLEY AND LARDNER LLP;SUITE 500, 3000 K STREET NW, WASHINGTON, DC, 20007, US

(73) Assignee: Johnson Controls Interiors GmbH & Co. KG, Grefrath (DE)

(21) Appl. No.: 10/576,958

(22) PCT Filed: Nov. 25, 2005
(86) PCT No.: PCT/EP05/12623

§ 371 Date: May 13, 2009

(30) Foreign Application Priority Data
Dec. 7, 2004 (DE) 10 2004 059 066.4

(51) Int. Cl. B29C 45/14; B32B 27/32

(52) U.S. Cl. 428/523; 264/255; 425/110

(57) ABSTRACT

In the case of a method for producing a heterogeneous, in particular multicolored, sheet-like structure, for example a decorative skin for an interior trim part of a vehicle, at least a first cavity and a second cavity of a mold are filled with at least a first and a second polymer material which are free-flowing and after removal form a one-piece sheet-like structure. At least during the filling of one cavity, a sealing element is arranged in the mold and extends along the parting plane in relation to the neighboring cavity.

### CROSS REFERENCE TO RELATED APPLICATIONS

The present invention claims priority as a national stage application of International Patent Application Serial No. PCT/EP 05/012623 filed on Nov. 25, 2005; and German Patent Application Serial No. DE 102004059066.4 filed on Dec. 7, 2004, which are both hereby incorporated herein by reference in their entirety.

### BACKGROUND

The invention relates to a method for producing a heterogeneous, in particular multicolored, sheet-like structure, for example a decorative skin for an interior trim part of a vehicle, and to molds suitable for this purpose and to sheet-like structures produced thereby.

Patent application DE 102 11 663 A1 discloses a method for producing a heterogeneous, but one-piece, molded part, which consists in certain regions of a hard, thermoplastic material, for example polypropylene (PP) or a PP compound, and an elastically deformable material, for example an olefin-based thermoplastic elastomer. The first and second segments of the molded part are produced in separate molds and subsequently joined to form a unit by molding on a connecting segment.

This method is suitable for producing small molded parts of complex geometry and high-value appearance, but is less suitable for producing large, sheet-like structural members, in particular decorative skins for interior trim parts, on account of the awkward handling of the extended segments of the structural member.

### SUMMARY

The invention is based on the problem of providing a method for producing high-value and heterogeneous, in particular at least two-colored, sheet-like structures.

The problem is solved according to the invention in the case of this method by at least a first cavity and a second cavity of a mold being filled with at least a first and a second polymer material which are free-flowing and after removal form a one-piece sheet-like structure, a sealing element being arranged in the mold, at least during the filling of one cavity, and extends along the parting plane in relation to the neighboring cavity.

The sealing element achieves the effect of reliable segmentation of the surface of the one-piece molded skin in the case of an extended and possibly complexly shaped longitudinal extent of the parting plane. In particular in the case of multicolored sheet-like structures, a distinct separation is created between the adjacent, differently colored surface regions, so that the molded skin is suitable for use in particularly demanding application areas of automobile construction.

A suitable mold for carrying out the method has at least a first mold part and a second mold part, which can be displaced with respect to said first part, which mold parts form at least a first cavity and a neighboring second cavity, which can be filled with at least a first and a second free-flowing polymer material, after the closing of the mold. According to the invention, a sealing element is arranged along the parting plane between the first cavity and the second cavity.

The following developments of the method can be used with particular advantage when reactively curing polymer materials are used, injected into the cavities by means of an injection-molding process (Reaction Injection Molding (RIM)). These polymers have a particularly low viscosity in the free-flowing state, so that the sealing between the cavities assumes special significance.

According to a first embodiment of the method according to the invention, the sealing element is firmly connected to one mold part, in particular the upper mold, and can be pressed against another mold part, in particular the lower mold. The sealing element is preferably expandable under fluid pressure (“inflatable seal”) and can be pressed against a protruding projection of the other mold part, in particular the lower mold.

After the filling of the first cavity with the first polymer material, the sealing element can be lifted off the other mold part and the second cavity filled with the second polymer material, the first and second polymer materials bonding with each other in such a way that they fuse together but appear distinctly separate. The lifting off of the seal preferably takes place by reducing the fluid pressure inside the tube-like seal, it also being possible to set a fluid pressure that lies below the ambient pressure. This creates a lifting-off force which exceeds the elastic recovery of the sealing element.

In the case of a mold that can be used here, the sealing element is preferably firmly arranged in one mold part, in particular the upper mold, and can be pressed against the other mold part, in particular the lower mold, in an expandable manner under fluid pressure.

According to another embodiment of the invention, before the filling of the cavities, the sealing element is loosely placed into one mold part, in particular the upper mold, in the region of the parting plane, and, during the closing of the mold, is made to bear in a sealing manner against the other mold part, in particular the lower mold.

The sealing element can advantageously be pressed against a protruding projection of the other mold part, in particular the lower mold, and, during the filling of the cavities, bonds with the first polymer material on the one hand and the second polymer material on the other hand in such a way that they fuse together. The sealing element is therefore lost in the production of the molded skin and must be replaced by a new sealing element before renewed filling of the cavities.

In the case of a suitable mold, the sealing element can be loosely placed into one mold part, in particular the upper mold, and can be pressed against the other mold part, in particular the lower mold.

### BRIEF DESCRIPTION OF THE FIGURES

The figures present various embodiments of the invention schematically and by way of example.

FIGS. 1a-e show how a first method according to the invention is carried out using a first mold suitable for this purpose,

FIGS. 2a-e shows a mold and a method according to another development of the invention.

### DETAILED DESCRIPTION OF THE PREFERRED AND EXEMPLARY EMBODIMENTS

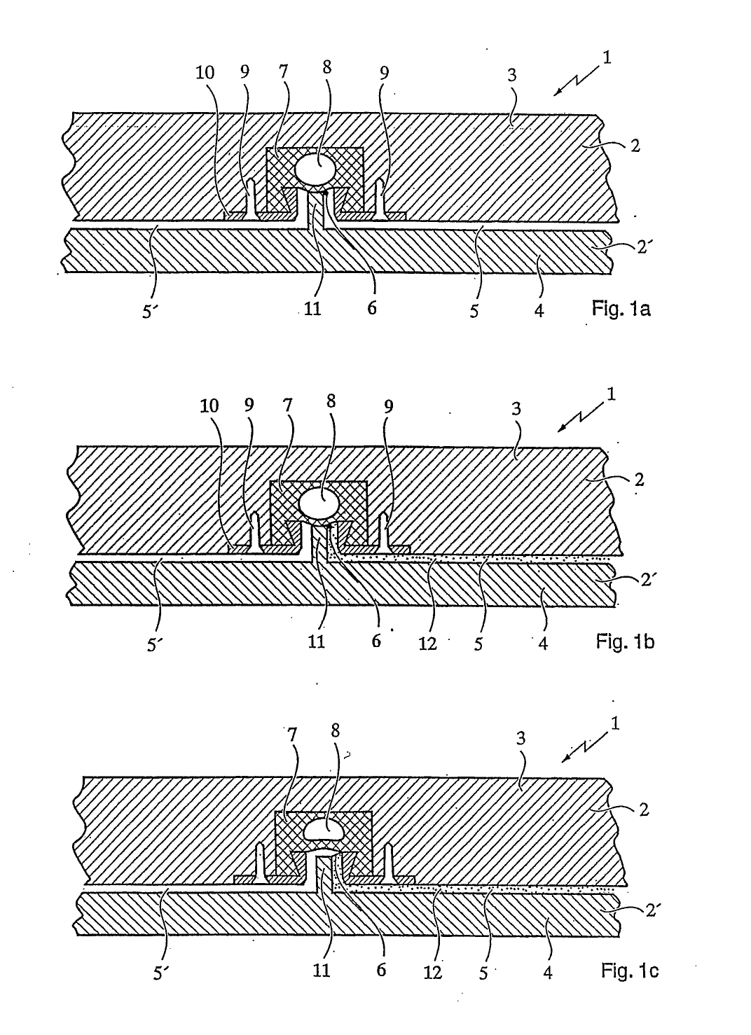

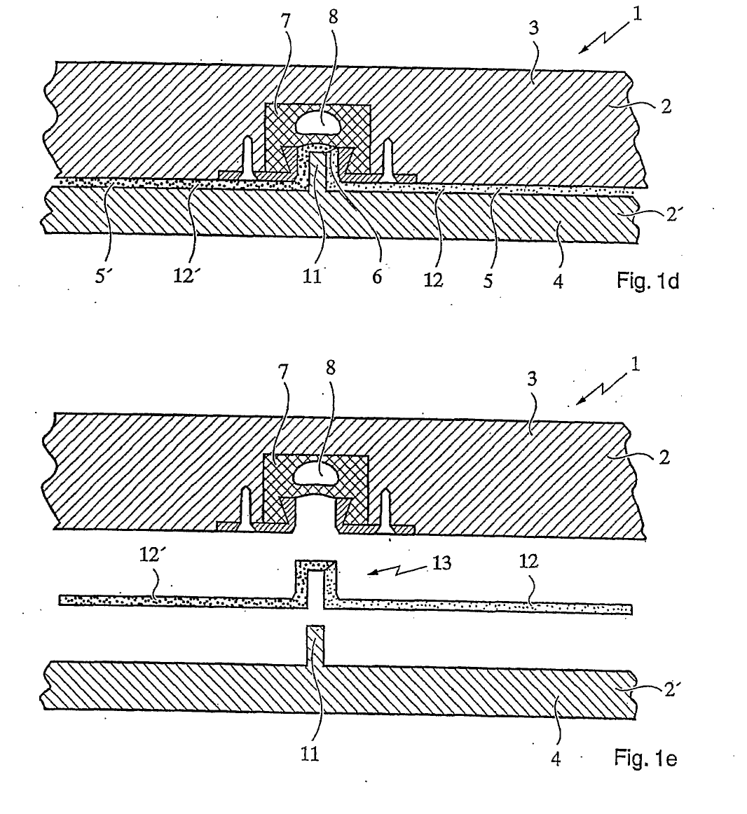

The mold 1 shown in FIGS. 1a to 1d comprises a first mold part 2 in the form of the upper mold 3 and a lower mold 4, forming a second mold part 2′. The upper mold 3 and the lower mold 4 can be displaced in relation to each other and, in their position for use as shown in FIG. 1a, form a first cavity 5 and a second cavity 5′. The cavities, extending in a two-dimensional manner, can be filled with different free-flowing polymer materials by means of injection-molding units (not shown) and are suitable for the production of sheet-like structures which have a very small thickness in relation to their length and width. The cavities do not have to be formed in a planar manner, but may also have a curved profile for the production of complexly shaped decorative skins.

The upper mold 3 is provided along the parting plane 6 between the neighboring cavities 5, 5′ with a tubular sealing element 7, the hollow space 8 of which can be filled with a compressed gas after the closing of the mold parts 2, 2′. The sealing element 7 is firmly connected to the mold upper part 3 by means of a securing means 10, which can be fixed by screws 9. As a result of the positive pressure, the sealing element 7, the longitudinal extent of which may likewise have a complex profile, expands elastically and comes to lie in a sealing manner against a projection 11 protruding from the lower mold 4. Subsequently, as can be seen from FIG. 1b, the first cavity 5 is filled with a low-viscosity first polymer material 12, which is gray for example, is prevented by the sealing element 7 from passing over into the second cavity 5′ and cures in the first cavity 5 as the result of a chemical reaction.

Subsequently, the hollow space 8 of the sealing element 7 is subjected to negative pressure, so that the sealing element 7 lifts off from the projection 11 (FIG. 1c). The second polymer material 12′, which is subsequently injected into the second cavity 5′ and is black for example, penetrates as far as the first polymer material 12 and bonds with it during the reactive curing in such a way that they fuse together. After the opening of the mold 1 (FIG. 1f), the two-colored sheet-like structure 13 obtained in this way can be removed.

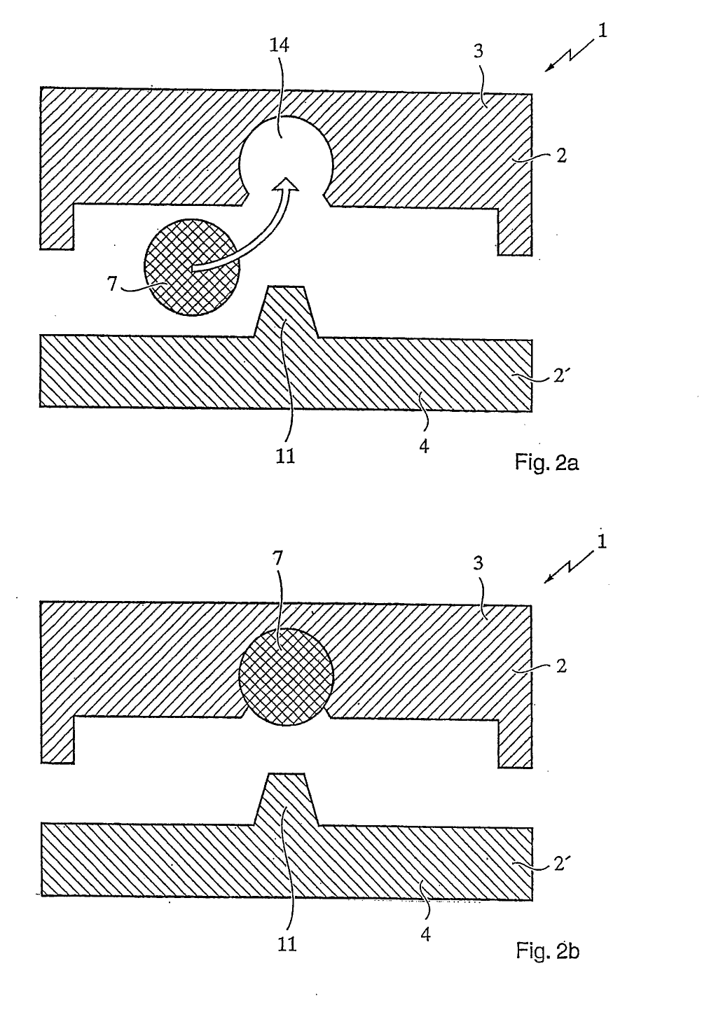

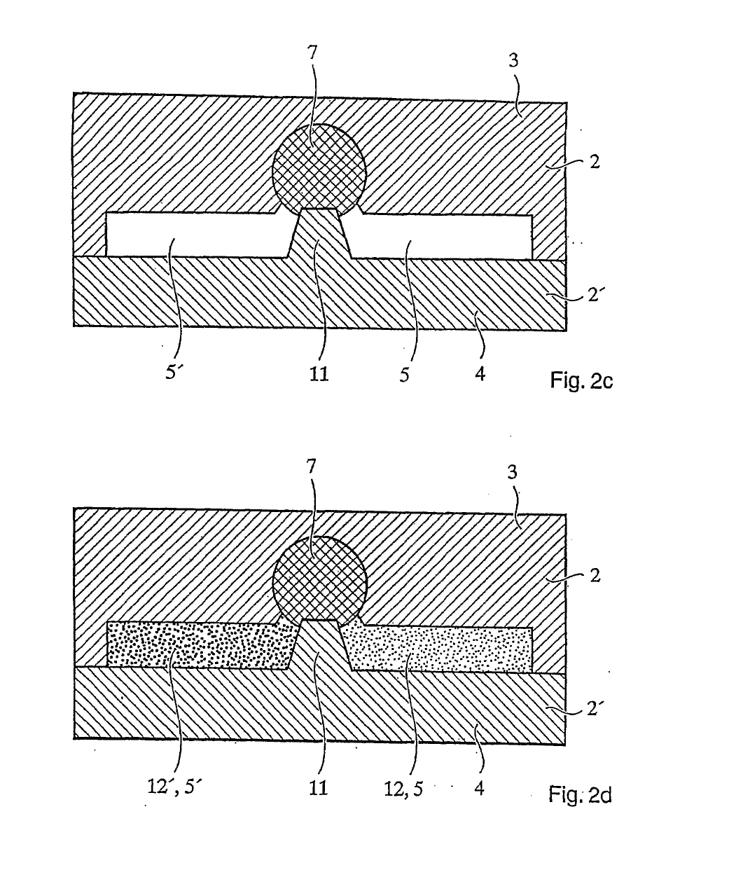

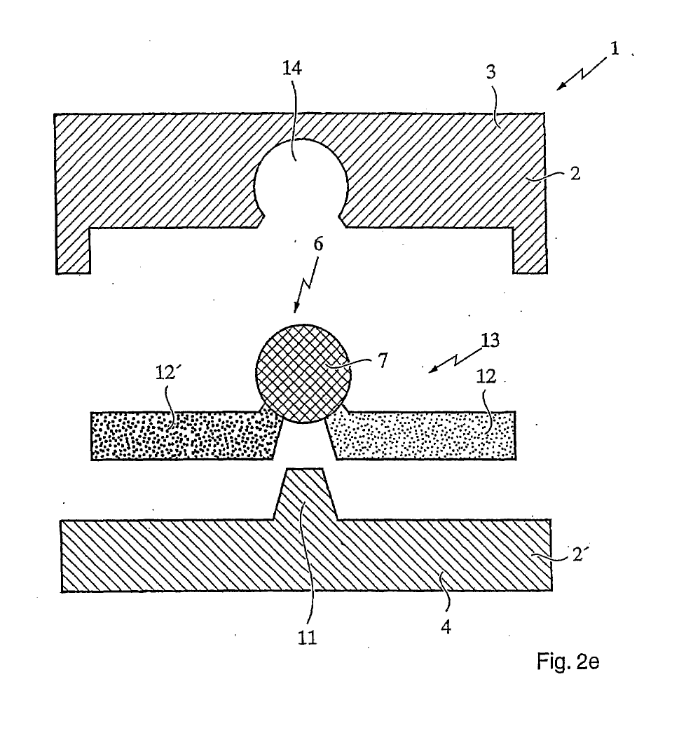

The mold as shown in FIG. 2a, intended for carrying out another method according to the invention, likewise has two mold parts 2, 2′ in the form of an upper mold 3 and a lower mold 4, the lower mold 4 likewise being provided with a projection 11. On its side facing the projection 11, the upper mold is provided with a groove-like receptacle 14 for the clamping, but releasable, securement of an elastic sealing element 7 in the form of a strand (FIG. 2b).

After the closing of the mold 1 (FIG. 2c), the two cavities 5, 5′, neighboring but separated by the sealing element, are filled with differently colored, free-flowing polymer materials 12, 12′, which penetrate as far as the sealing element and bond with the latter in such a way that they fuse together (FIG. 2d).

As shown in FIG. 2e, after the curing of the polymer materials 12, 12′ and the opening of the mold 1, the one-piece sheet-like structure 13 including the lost sealing element 7 can be removed. Apart from the colors of the first and second polymer materials 12, 12′, the sheet-like structure 13 may of course have another color, determined by the sealing element 7, in the region of the parting plane 6.

### DESIGNATIONS

1 mold
2 mold part
3 upper mold
4 lower mold
5 cavity
6 parting plane
7 sealing element
8 hollow space
9 screw
10 securing means
11 projection
12 polymer material
13 sheet-like structure
14 receptacle

1-14. (canceled)

15. A method for making a vehicle component comprising:
providing a mold and a sealing element;
arranging the sealing element in the mold to bear in a sealing manner against the mold to define a first cavity and a second cavity;
introducing at least a first polymer material into the first cavity and introducing a second polymer material into the second cavity to form a one-piece structure.

16. The method of claim 15 wherein the step of arranging the sealing element comprises loosely placing the sealing element into a first mold section of the mold, and further comprising closing the mold and sealing the sealing element against a second mold section of the mold.

17. The method of claim 16 wherein the step of arranging the sealing element occurs before the polymer material is introduced into the first cavity and before the second polymer material is introduced into the second cavity.

18. The method of claim 17 further comprising pressing the sealing element against a projection projecting from the second mold section.

19. The method of claim 18 wherein during the step of introducing the first polymer material into the first cavity and introducing the second polymer material into the second cavity, the sealing element bonds with the first polymer material and the second polymer material.

20. The method of claim 19 wherein during the step of introducing the first polymer material into the first cavity and introducing the second polymer material into the second cavity, the sealing element fuses with the first polymer material and the second polymer material.

21. The method of claim 20 wherein the step of introducing the first polymer material into the first cavity and introducing the second polymer material into the second cavity comprises injection molding and reactively curing the first polymer material and the second polymer.

22. The method of claim 21 wherein injection molding and reactively curing polymer materials comprises reaction injection molding (RIM).

23. The method of claim 15 wherein the first polymer material and second polymer material comprise low viscosity materials.

24. The method of claim 15 wherein the step of arranging the sealing element occurs at least during the step of introducing the first polymer material into the first cavity and the second polymer material into the second cavity.

25. The method of claim 15 wherein the vehicle component comprises a multiple color decorative skin.

26. The method of claim 15 wherein the step of arranging the sealing element comprises firmly connecting the sealing element to a first mold section of the mold and pressing the sealing element against a second mold section of the mold.

27. The method of claim 15 further comprising expanding the sealing element with fluid pressure.

28. The method of claim 15 further comprising lifting the sealing element off of the second mold section before the step of introducing the second polymer material into the second cavity.

29. The method of claim 15 wherein the step of introducing the first polymer material into the first cavity and introducing the second polymer material into the second cavity comprises introducing the first polymer material with a first color into the first cavity and introducing the second polymer material with a second color different than the first color into the second cavity.

30. A mold for making a vehicle component comprising:
a first mold section;
a second mold section that can be displaced with respect to the first mold section, wherein the first mold section and the second mold section form a first cavity that can receive at least a first free-flowing polymer material, and a neighboring second cavity that can receive at least a second free-flowing polymer material;
a sealing element arranged along the parting plane between the first cavity and the second cavity;
wherein the sealing element is loosely placed into one of the first mold section and the second mold section and can be pressed against the other of the first mold section and the second mold section.

31. The mold of claim 30 wherein the sealing element is firmly arranged in the first mold section and pressed against the second mold section when expanded under fluid pressure.

32. The mold of claim 30 wherein the sealing element is loosely placed into the first mold section and is pressed against the second mold section.

33. A vehicle component comprising:
a first portion made from a free-flowing, low viscosity first polymer material;
a second portion made from a free-flowing, low viscosity second polymer material;
a sealing element arranged along the parting plane between the first portion and the second portion;
wherein the sealing element bonds with the first polymer material and the second polymer material.

34. The vehicle component of claim 33 wherein the sealing element is fused with the first polymer material and the second polymer material.

35. The vehicle component of claim 33 wherein the first polymer material comprises a first color and the second polymer material comprises a second color different than the first color.
